(19) United States
(12) Patent Application Publication
(10) Pub. No.: US 2009/0128092 A1
(43) Pub. Date: May 21, 2009

(54) BASE CASE BATTERY WITH STORAGE

(76) Inventor: Steven Woud, Los Angeles, CA (US)

Correspondence Address: PARK LAW FIRM, 3255 WILSHIRE BLVD, SUITE 1110, LOS ANGELES, CA, 90010, US

(21) Appl. No.: 11/940,620

(22) Filed: Nov. 15, 2007

(51) Int. Cl. G06F 1/16; H02J 7/00; G06F 13/00

(52) U.S. Cl. 320/113

(57) ABSTRACT

An aspect of the invention provides a base case battery for a portable personal computer. The base case battery includes a base case, a charging portion, a storage device, and holding portions. The charging portion is disposed in the base case, and configured to be electrically connected to the power input of the portable personal computer through a first connector. The storage device is disposed in the base case, and configured to be electrically connected to the portable personal computer through a second connector. The holding portions are disposed on the base case, and each of the holding portions is configured to mechanically connect the base case to the portable personal computer detachably. The charging portion is configured to extend the usage time of the portable personal computer, and the storage device is configured to extend the storage capacity of the memory of the portable personal computer.

### BACKGROUND OF THE INVENTION

The present invention relates to a base case battery with storage. More particularly, this invention relates to a base case battery with storage device, which extends the usage time of a portable personal computer with more electrical power provided in a charging portion of the base case battery and provides more memory space to the portable personal computer.

“Portable” is one of the keywords which define the era of the information technology. Computing power had been an obstacle to make the technology portable for a long time. Considering the first computer, it would be easy to understand the situation. With the advent of the transistors and integrated circuit, however, computing power can be crammed in a really small space such that locating the heart of a computer inside the computer or even on a mother board is not easy, actually challenging to a layman. Once the computing power became no problem for a portability, it has taken a very short time to recognize the hard fact that the power source of battery is a real problem, which seems to be much harder to solve than the CPU problem.

Since 1990's, portable electronic devices such as a portable personal computer have become indispensable commodities to every one. Still, the portable electronic devices need to be charged very frequently such that the usage is critically limited.

Also, the portable personal computer needs more and more memory space with the ever-increasing demand from the big software. Recently, certain type of portable personal computer needs to be provided with a large capacity of extra memory to perform advanced functions.

Accordingly, a need for a base case battery with storage device for a portable personal computer or a portable personal electronic device has been present for a long time considering the expansive demands of touch and complicated cleansing in the everyday life. This invention is directed to solve these problems and satisfy the long-felt need.

### SUMMARY OF THE INVENTION

The present invention contrives to solve the disadvantages of the prior art.

An objective of the invention is to provide a base case battery for a portable personal computer.

Another object of the invention is to provide a base case battery for a portable personal computer, which extend the usage time and provide more memory space to the portable personal computer.

Still another object of the invention is to provide a base case battery for a portable personal computer, which can be installed on various types of portable personal computers.

An aspect of the invention provides a base case battery for a portable personal computer. The base case battery includes a base case, a charging portion, a storage device, and a plurality of holding portions.

The portable personal computer may include a central processing unit, a memory, a battery, and a power input.

The base case has a top surface, a bottom surface, a plurality of side surfaces, and a plurality of corners, and the top surface has a substantially same shape as a bottom surface of the portable personal computer.

The charging portion is disposed in the base case, and configured to be electrically connected to the power input of the portable personal computer through a first connector so as to provide electrical power to the portable personal computer while the portable personal computer is attached to the base case.

The storage device is disposed in the base case, and configured to be electrically connected to the portable personal computer through a second connector so as to be accessed by the portable personal computer while the portable personal computer is attached to the base case.

The plurality of holding portions are disposed on the base case, and each of the holding portions is configured to mechanically connect the base case to the portable personal computer detachably.

The charging portion is configured to extend the usage time of the portable personal computer, and the storage device is configured to extend the storage capacity of the memory of the portable personal computer.

The base case may further comprise a plurality of connectors provided on the top surface of the base case, and the plurality of connectors may be configured to be connected to the first connector of the charging portion and the second connector of the storage device.

The top surface of the base case may be substantially flat, and the portable personal computer may be installed on the top surface.

The bottom surface of the base case may be configured to be put on a surface.

The charging portion may comprise an electrical power acceptor configured to accept electrical power from outside. The charging portion may further comprise a secondary battery, and the electrical power acceptor may be configured to charge the secondary battery using an external electrical power source. The charging portion may further comprise a primary battery and a receptacle configured to accept the primary battery.

The storage device may further comprise a hard disc and a flash memory.

The base case may have a shape of rectangle including four corners, and each of the holding portions may extend from one of the four corners substantially perpendicularly toward the portable personal computer.

Each of the plurality of holding portions may comprise: one or more vertical plates configured to enclose and engage one corner of the portable personal computer; and a horizontal plate extended from the one or more vertical plates substantially perpendicularly.

The one or more vertical plates and the horizontal plate may be flexible so as to be configured to accept, hold, and release the portable personal computer. The horizontal plate may comprise a retractable latch configured to be either in a first position or a second position. When the horizontal plate is in the first position the portable personal computer is allowed to be pushed in between the one or more vertical plates, and when the horizontal plate is in the second position the portable personal computer is locked in between the one or more vertical plates.

The charging portion may comprise one or more connectors configured to be electrically connected to the power input of the portable personal computer, and the one or more connectors are disposed on the top surface of the base case at a corresponding location of the power input of the portable personal computer.

The base case may further comprise a plurality of sound exit holes configured to guide sound from the plurality of speakers of the portable personal computer.

The base case may further comprise one or more ventilation holes configured to guide air from ventilation holes of the portable personal computer.

The storage device may comprise a hard disc and a flash memory.

Another aspect of the invention provide a base case battery with storage, comprising: a main base portion, disposed below the portable personal computer, comprising a top surface, a bottom surface, a plurality of edges, and a plurality of first connecting portions provided on the plurality of edges; a plurality of edge extension portions, each of which being extended from one of the plurality of edges of the main base portion, wherein each of the plurality of edge extension portions comprises a second connecting portion which corresponds to at least one of the plurality of first connecting portions; a plurality of holding portions extended from the plurality of edge extension portions and the main base portion, each of the plurality of holding portions being configured to mechanically hold the portable personal computer detachably; a charging portion disposed in the main base portion, the charging portion being configured to be electrically connected to a power input of the portable personal computer through a first connector so as to provide electrical power to the portable personal computer while the portable personal computer is attached to the base case; and a storage device disposed in the main base potion, the storage device being configured to be electrically connected to the portable personal computer through a second connector so as to be accessed by the portable personal computer while the portable personal computer is attached to the base case, wherein the charging portion is configured to extend the usage time of the portable personal computer, and wherein the storage device is configured to extend the storage capacity of the memory of the portable personal computer.

The first connecting portion may comprise a female channel provided along one of the plurality of edges of the main base portion, and the second connecting portion may comprise a male channel provided along one of the plurality of edges of the plurality of edge extension portions.

The dimension of the main base portion and the plurality of edge extension portions may be determined by the portable personal computer.

The advantages of the present invention are: (1) the base case battery with storage can extend the usage time of the portable personal computer; (2) the base case battery with storage can provide more memory space; and (3) the base case battery with storage is adaptable to various type of portable personal computer.

Although the present invention is briefly summarized, the fuller understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIG. 1 is a perspective view showing a base case battery with storage installed on a portable personal computer according to an embodiment of the present invention;

FIG. 2 is a side view of the base case battery with storage of FIG. 1;

FIG. 3 is a front plan view of a base case battery with storage of FIG. 1;

FIG. 4 is a top plan view and front plan view of a base case to another embodiment of the invention; and

FIG. 5 is a partially enlarged view illustrating two positions of a horizontal plate of a holding portion according to an embodiment of the invention.

### DETAILED DESCRIPTION EMBODIMENTS OF THE INVENTION

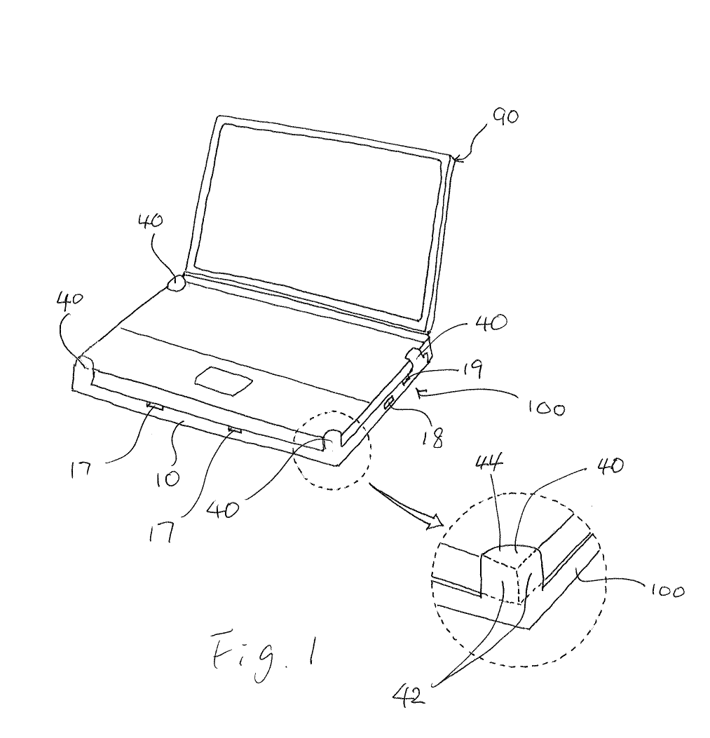

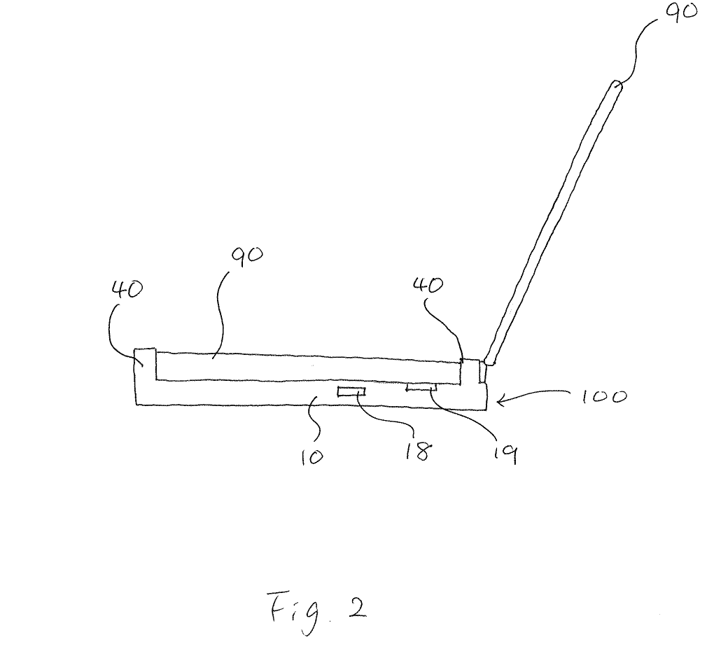

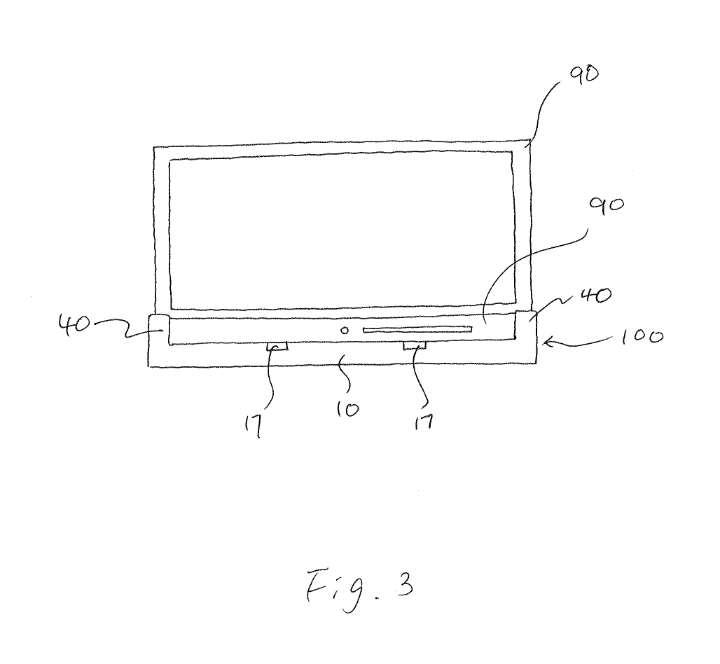

FIGS. 1-5 show a base case battery with storage 100 according to an embodiment of the invention.

The base case battery 100 includes a base case 10, a charging portion 20, a storage device 30, and a plurality of holding portions 40.

The portable personal computer 90 may include a central processing unit, a memory, a battery, and a power input (not shown).

The base case 10 has a top surface, a bottom surface, a plurality of side surfaces, and a plurality of corners (not shown), and the top surface has a substantially same shape as a bottom surface of the portable personal computer 90.

The charging portion 20 is disposed in the base case 10, and configured to be electrically connected to the power input of the portable personal computer 90 through a first connector 22 so as to provide electrical power to the portable personal computer 90 while the portable personal computer 90 is attached to the base case 10.

The storage device 30 is disposed in the base case 10, and configured to be electrically connected to the portable personal computer 90 through a second connector 32 so as to be accessed by the portable personal computer 90 while the portable personal computer 90 is attached to the base case 10.

The plurality of holding portions 40 are disposed on the base case 10, and each of the holding portions 40 is configured to mechanically connect the base case 10 to the portable personal computer 90 detachably.

The charging portion 20 is configured to extend the usage time of the portable personal computer 90, and the storage device 30 is configured to extend the storage capacity of the memory of the portable personal computer 90.

The base case 10 may further comprise a plurality of connectors provided on the top surface of the base case 10, and the plurality of connectors may comprise the first connector 22 of the charging portion 20 and the second connector 32 of the storage device 30.

The top surface of the base case 10 may be substantially flat, and the portable personal computer 90 may be installed on the top surface of the base case 10.

The bottom surface of the base case 10 may be configured to be put on a surface. The surface may include a table top, a desk top, and a floor.

The charging portion 20 may comprise an electrical power acceptor 18 configured to accept electrical power from outside. The charging portion 20 may further comprise a secondary battery, and the electrical power acceptor may be configured to charge the secondary battery using an external electrical power source. The charging portion 20 may further comprise a primary battery and a receptacle configured to accept the primary battery.

The storage device 30 may further comprise a hard disc and a flash memory.

The base case 10 may have a shape of rectangle including four corners, and each of the holding portions may extend from one of the four corners substantially perpendicularly toward the portable personal computer 90.

Each of the plurality of holding portions 40 may comprise: one or more vertical plates 42 configured to enclose and engage one corner of the portable personal computer 90; and a horizontal plate 44 extended from the one or more vertical plates 42 substantially perpendicularly as shown in FIG. 1.

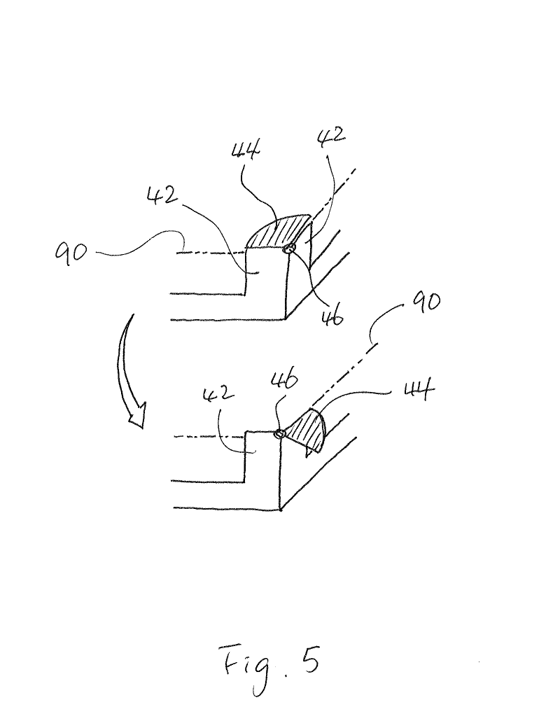

The one or more vertical plates 42 and the horizontal plate 44 may be flexible so as to be configured to accept, hold, and release the portable personal computer 90. The horizontal plate 44 may comprise a hinge 46, about which the horizontal plate 44 is configured to be either in a first position (bottom) or a second position (top) as shown in FIG. 5. When the horizontal plate 44 is in the first position the portable personal computer 90 is allowed to be pushed in between the one or more vertical plates 42, and when the horizontal plate 44 is in the second position the portable personal computer 90 is locked in between the one or more vertical plates 42. In certain embodiments, a retractable latch device (not shown) may be used instead of the hinge 46.

The charging portion 20 may comprise one or more connectors 22 configured to be electrically connected to the power input of the portable personal computer 90, and the one or more connectors 22 are disposed on the top surface of the base case 10 at a corresponding location of the power input of the portable personal computer 90.

The base case 10 may further comprise a plurality of sound exit holes 17 configured to guide sound from the plurality of speakers of the portable personal computer 90. The locations of the sound exit holes 17 may be determined by the location of speakers of the portable personal computer 90.

The base case 10 may further comprise one or more ventilation holes 19 configured to guide air from ventilation holes of the portable personal computer 90. The locations of the ventilation holes 19 may be determined by the location of ventilation holes of the portable personal computer 90.

The storage device 30 may comprise a hard disc and a flash memory.

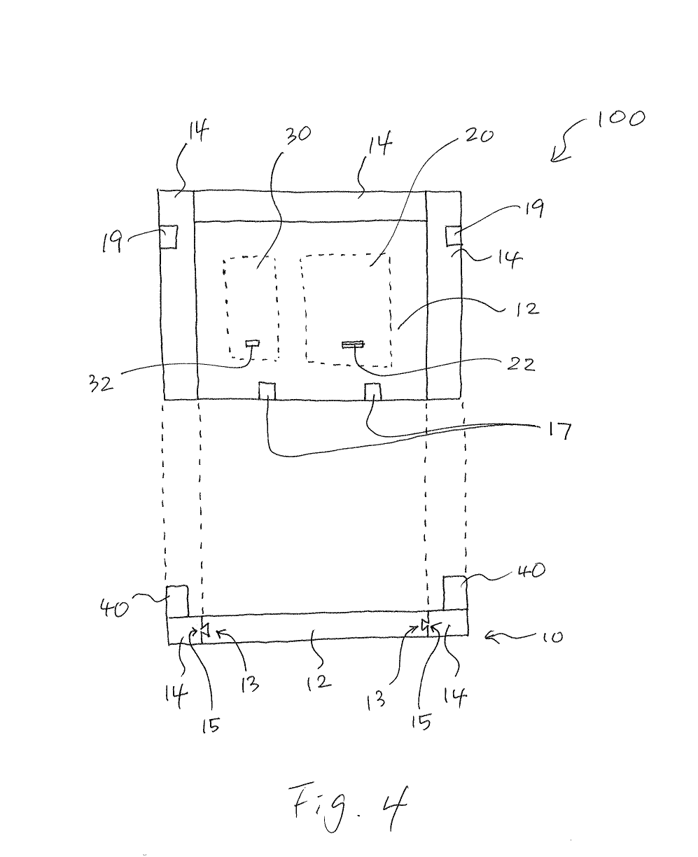

As shown in FIG. 4, another aspect of the invention provide a base case battery with storage 100, comprising: a main base portion 12, disposed below the portable personal computer 90, comprising a top surface, a bottom surface, a plurality of edges, and a plurality of first connecting portions 13 provided on the plurality of edges; a plurality of edge extension portions 14, each of which being extended from one of the plurality of edges of the main base portion 12, and each of the plurality of edge extension portions 14 comprises a second connecting portion 15 which corresponds to at least one of the plurality of first connecting portions 13; a plurality of holding portions 40 extended from the plurality of edge extension portions 14 and the main base portion 12, each of the plurality of holding portions 40 being configured to mechanically hold the portable personal computer 90 detachably; a charging portion 20 disposed in the main base portion 12, the charging portion 20 being configured to be electrically connected to a power input of the portable personal computer 90 through a first connector 22 so as to provide electrical power to the portable personal computer 90 while the portable personal computer 90 is attached to the base case 10; and a storage device 30 disposed in the main base potion 12, the storage device 30 being configured to be electrically connected to the portable personal computer 90 through a second connector 32 so as to be accessed by the portable personal computer 90 while the portable personal computer 90 is attached to the base case 10, wherein the charging portion 20 is configured to extend the usage time of the portable personal computer 90, and wherein the storage device 30 is configured to extend the storage capacity of the memory of the portable personal computer 90.

The first connecting portion 13 may comprise a female channel provided along one of the plurality of edges of the main base portion 12, and the second connecting portion 15 may comprise a male channel provided along one of the plurality of edges of the plurality of edge extension portions 14.

The dimension of the main base portion 12 and the plurality of edge extension portions 14 may be determined by the portable personal computer 90. In certain embodiments, the main base portion 12 is fixed with a dimension, and the dimension of the edge extension portions 14 may be determined according to the portable personal computer 90. Since the edge extension portion 14 does not contain the charging portion 20 or the storage device 30, it can be provided for different portable personal computers 90 for a single main base portion 12.

In still another embodiments, the charging portion 20 or the storage device 30 may be included in the edge extension portions 14.

While the invention has been shown and described with reference to different embodiments thereof, it will be appreciated by those skilled in the art that variations in form, detail, compositions and operation may be made without departing from the spirit and scope of the invention as defined by the accompanying claims.

What is claimed is:

1. A base case battery with storage for a portable personal computer with a central processing unit, a memory, a battery, and a power input, the base case battery with storage comprising:
a base case having a top surface, a bottom surface, a plurality of side surfaces, and a plurality of corners, wherein the top surface has a substantially same shape as a bottom surface of the portable personal computer;
a charging portion disposed in the base case, the charging portion being configured to be electrically connected to the power input of the portable personal computer through a first connector so as to provide electrical power to the portable personal computer while the portable personal computer is attached to the base case;
a storage device disposed in the base case, the storage device being configured to be electrically connected to the portable personal computer through a second connector so as to be accessed by the portable personal computer while the portable personal computer is attached to the base case; and
a plurality of holding portions disposed on the base case, each of the plurality of holding portions being configured to mechanically connect the base case to the portable personal computer detachably,
wherein the charging portion is configured to extend the usage time of the portable personal computer, and wherein the storage device is configured to extend the storage capacity of the memory of the portable personal computer.

2. The base case battery of claim 1, wherein the base case further comprises a plurality of connectors provided on the top surface of the base case, wherein the plurality of connectors are configured to be connected to the first connector of the charging portion and the second connector of the storage device.

3. The base case battery of claim 1, wherein the top surface of the base case is substantially flat, and wherein the portable personal computer is installed on the top surface.

4. The base case battery of claim 1, wherein the bottom surface of the base case is configured to be put on a surface.

5. The base case battery of claim 1, wherein the charging portion comprises an electrical power acceptor configured to accept electrical power from outside.

6. The base case battery of claim 5, wherein the charging portion further comprises a secondary battery, and wherein the electrical power acceptor is configured to charge the secondary battery using an external electrical power source.

7. The base case battery of claim 5, wherein the charging portion further comprises a primary battery and a receptacle configured to accept the primary battery.

8. The base case battery of claim 1, wherein the storage device further comprises a hard disc and a flash memory.

9. The base case battery of claim 1, wherein the base case has a shape of rectangle including four corners, wherein each of the plurality of holding portions extends from one of the four corners substantially perpendicularly toward the portable personal computer.

10. The base case battery of claim 9, wherein each of the plurality of holding portions comprises:
one or more vertical plates configured to enclose and engage one corner of the portable personal computer; and
a horizontal plate extended from the one or more vertical plates substantially perpendicularly.

11. The base case battery of claim 10, wherein the one or more vertical plates and the horizontal plate are flexible so as to be configured to accept, hold, and release the portable personal computer.

12. The base case battery of claim 10, wherein the horizontal plate comprises a retractable latch configured to be either in a first position or a second position, wherein when the horizontal plate is in the first position the portable personal computer is allowed to be pushed in between the one or more vertical plates, and wherein when the horizontal plate is in the second position the portable personal computer is locked in between the one or more vertical plates.

13. The base case battery of claim 1, wherein the charging portion comprises one or more connectors configured to be electrically connected to the power input of the portable personal computer, wherein the one or more connectors are disposed on the top surface of the base case at a corresponding location of the power input of the portable personal computer.

14. The base case battery of claim 1, wherein the base case further comprises a plurality of sound exit holes configured to guide sound from the plurality of speakers of the portable personal computer.

15. The base case battery of claim 1, wherein the base case further comprises one or more ventilation holes configured to guide air from ventilation holes of the portable personal computer.

16. The base case battery of claim 1, wherein the storage device comprises a hard disc and a flash memory.

17. A base case battery with storage for a portable personal computer, the base case battery with storage comprising:
a main base portion, disposed below the portable personal computer, comprising a top surface, a bottom surface, a plurality of edges, and a plurality of first connecting portions provided on the plurality of edges;
a plurality of edge extension portions, each of which being extended from one of the plurality of edges of the main base portion, wherein each of the plurality of edge extension portions comprises a second connecting portion which corresponds to at least one of the plurality of first connecting portions;
a plurality of holding portions extended from the plurality of edge extension portions and the main base portion, each of the plurality of holding portions being configured to mechanically hold the portable personal computer detachably;
a charging portion disposed in the main base portion, the charging portion being configured to be electrically connected to a power input of the portable personal computer through a first connector so as to provide electrical power to the portable personal computer while the portable personal computer is attached to the base case; and
a storage device disposed in the main base potion, the storage device being configured to be electrically connected to the portable personal computer through a second connector so as to be accessed by the portable personal computer while the portable personal computer is attached to the base case,
wherein the charging portion is configured to extend the usage time of the portable personal computer, and wherein the storage device is configured to extend the storage capacity of the memory of the portable personal computer.

18. The base case battery of claim 17, wherein the first connecting portion comprises a female channel provided along one of the plurality of edges of the main base portion, and wherein the second connecting portion comprises a male channel provided along one of the plurality of edges of the plurality of edge extension portions.

19. The base case battery of claim 17, wherein dimension of the main base portion and the plurality of edge extension portions is determined by the portable personal computer.
